(19) United States
(12) Patent Application Publication
(10) Pub. No.: US 2007/0280234 A1
(43) Pub. Date: Dec. 6, 2007

(54) Network element, system and method for providing multicast channels

(75) Inventors: Piero Sorrini, Ottawa (CA); Gatot Susilo, Kanata (CA)

Correspondence Address: Arnold B. Silverman, Esq.;Eckert Seamans Cherin & Mellott, LLC, 44th Floor, 600 Grant Street, Pittsburgh, PA, 15219, US

(73) Assignee: Alcatel

(21) Appl. No.: 11/444,613

(22) Filed: May 31, 2006

(51) Int. Cl. H04J 3/26

(52) U.S. Cl. 370/390; 370/432

(57) ABSTRACT

A network element comprises a multicast protocol module configured to connect to a switched layer 2 control channel, the control channel being for communicating, through a switched network, control signals for controlling the communication of multicast data between the network element and another network element. A method for providing multicast channels comprises establishing a layer 2 switched control channel through a switched network between two network elements. A P2MP (Point-to-Multipoint) switched connection is established in response to receiving a request for a multicast channel over the control channel and is used to send the data for the channel. A system comprising at least two network elements is configured to implement the method.

### FIELD OF THE INVENTION

The present invention relates to a network element, a system and a method for providing multicast channels.

### BACKGROUND

IPTV (Internet Protocol Television) broadcasts multicast channels through an IP network. A network termination node, such as a BRAS (Broadband Remote Access Server) distributes the channels to end user devices over network elements, such as ATM (Asynchronous Transfer Mode) nodes.

Current ATM DSLAM (Digital Subscriber Line Access Multiplexer) network architectures send all the broadcasted TV channels and other IP multicast traffic, such as radio broadcasts and video streams, to all nodes and DSLAMs in the network. This is an inefficient use of the nodes and of the DSLAM bandwidth because each node does not necessarily require all the data all the time. Furthermore, it limits the number of channels available to DSL (Digital Subscriber Line) subscribers. For example, due to bandwidth limitations at the DSLAMs, the current subscriber offering for IPTV is 100 channels. The bandwidth limitation is a result of currently deployed DSLAMs being connected using 622 Mbps STM4 links, with 400 Mbps reserved for video. Each channel requires 4 Mbps of bandwidth, thus limiting each DSLAM to 100 channels. However, competing technologies, such as satellite TV and cable TV, are able to provide subscribers with many more channels. Yet, to provide IPTV subscribers with say 250 channels using the current architecture would require approximately 1 Gbps of bandwidth.

One option for increasing the number of channels available to subscribers is to increase the bandwidth available for the multicast channels by adding new links to the DLSAMs. However, this option is very expensive.

Another option is to have one node between the multicast source and the DSLAMs act as an IGMP (Internet Group Management Protocol) proxy node. With this solution, when a DSLAM subscriber requests a video channel, the following actions occur:

1. If the DSLAM already has the video channel broadcast to it from the proxy node, the DSLAM will add the video channel to the subscriber link.

2. If the DSLAM does not have the video channel broadcast to it from the proxy node, the DSLAM will request the video channel by sending an IGMP REPORT message, over a static ATM P2P (Point-to-Point) control channel connection, to the proxy node, and then add the video channel to the subscriber link.

2a. Upon receiving the IGMP REPORT message from the DSLAM, if the proxy node already has the video channel broadcast to it from an upstream network element, the proxy node will add an ATM P2MP leaf of the video channel to the DSLAM.

2b. If the proxy node does not have the video channel broadcast to it from the upstream network element, the proxy node will request the video channel by sending an IGMP REPORT message, over an ATM P2P (Point-to-Point) control channel, to the upstream network element, and then add an ATM P2MP leaf of the video channel to the DSLAM.

This solution only works if the upstream network element is directly connected to the proxy node, and the proxy node is directly connected to the DSLAMs. Each node or DSLAM requires a table mapping the multicast group addresses to ATM P2MP connections for the channels. For this solution to work when an ATM network exists between any of the network elements on the path between the source of the multicast channels and the user devices, each node in the ATM network would need to be configured to have the table mapping of the multicast group addresses as well as support the IGMP protocol. Scaling this solution is also a difficult and unwieldy task

### SUMMARY OF THE INVENTION

According to one aspect of the invention, there is provided: a network element comprising: a multicast protocol module configured to connect to a switched layer 2 control channel, the control channel being for communicating, through a switched network, control signals for controlling the communication of multicast data between the network element and another network element.

In another aspect of the invention, there is provided a system for providing multicast channels, the system comprising: a first network element; a second network element separated from the first network element by a switched network, the second network element being in communication with the first network element via a layer 2 switched control channel through the switched network; the first network element configured to establish a P2MP (Point-to-Multipoint) switched connection between the first network element and the second network element in response to receiving from the first network element a request for a multicast channel over the control channel, the P2MP switched connection being for sending data for the multicast channel to the second network element.

In still another aspect of the invention, there is provided a method for providing multicast channels from a first network element to a second network element, the first network element and the second network element being separated by a switched network, the method comprising: establishing a layer 2 switched connection between the first network element and the second network element to be used as a control channel, the layer 2 switched connection being through the switched network; and using the layer 2 switched connection to communicate a request from the second network element to the first network element, the request being for a user selected multicast channel.

In a further aspect of the invention, there is provided a computer readable medium having computer readable instructions stored thereon for implementing any of the methods described herein.

By using a layer 2 control channel to communicate control signal over a layer 2 network directly to a multicast protocol module, there is no need to configure each node in the network with a table of multicast group addresses.

Advantageously, embodiments of the present invention is the provision of true dynamic multicasting of video channels to each DSLAM over an ATM network. This is accomplished by only establishing a leaf of a channel to the DSLAM if a request for the channel is sent by the DSLAM over a control channel through the ATM network.

Furthermore, embodiments that use ATM networks is that the industry proven ATM network robustness and resiliencies, such as the ability to automatically switch connections in the case of a failure on a path or circuit, can be applied to IPTV.

The use of SVC-IGMP (Switched Virtual Circuit-IGMP) control channel and P2MP SPVC (Soft Permanent Virtual Circuit) simplifies the IGMP proxy methodology over L2 platforms, such as ATM networks, by alleviating the need to configure each node between the IP network over which the multicast data is broadcast and the user device, such as a set-top box.

Additionally, by using an existing network, there is no requirement to connect upstream routers and downstream routers in the IPTV system with fiber or to co-locate the routers on the same premises. The routers may be on multiple sites and connected over an ATM network, which consists of several nodes.

Embodiments of the present invention allow providers to offer a wider selection of video channels in their networks. For example, the number of channels available to subscribers may be increased from 100 channels currently available to 250 channels with minimal provisioning.

Other aspects and features of the present invention will become apparent, to those ordinarily skilled in the art, upon review of the following description of embodiments of the invention.

### BRIEF DESCRIPTION OF THE DRAWINGS

Examples of embodiments of the invention will now be described in greater detail with reference to the accompanying drawings, in which:

FIG. 1 is a block diagram of a network element according to one embodiment of the present invention;

FIG. 2 is a schematic diagram of a system comprising a network element according to one embodiment of the present invention;

FIG. 3 is a block diagram of a network element according to one embodiment of the present invention;

FIG. 4 is a schematic diagram of a system comprising a network element according to one embodiment of the present invention;

FIG. 5 is a schematic diagram of a system comprising a network element according to one embodiment of the present invention;

FIG. 6 is a schematic diagram of a system according to one embodiment of the present invention;

FIG. 7 is a schematic diagram of a system according to one embodiment of the present invention;

FIG. 8 is a flowchart of a method according to one embodiment of the present invention; and

FIG. 9 is a flowchart of a method according to one embodiment of the present invention.

### DETAILED DESCRIPTION

In embodiments of the present invention, a layer 2 switched connection is used as a control channel for communicating control signals across a switched network, the control signals being for controlling the communication of multicast data. An exemplary embodiment of the layer 2 switched connection is an SVC (Switched Virtual Circuit) over an ATM network. In some embodiments a P2MP switched connection is established in response to receiving, over the control channel, a request for a multicast channel. The multicast data for that multicast channel is sent over the P2MP switched connection.

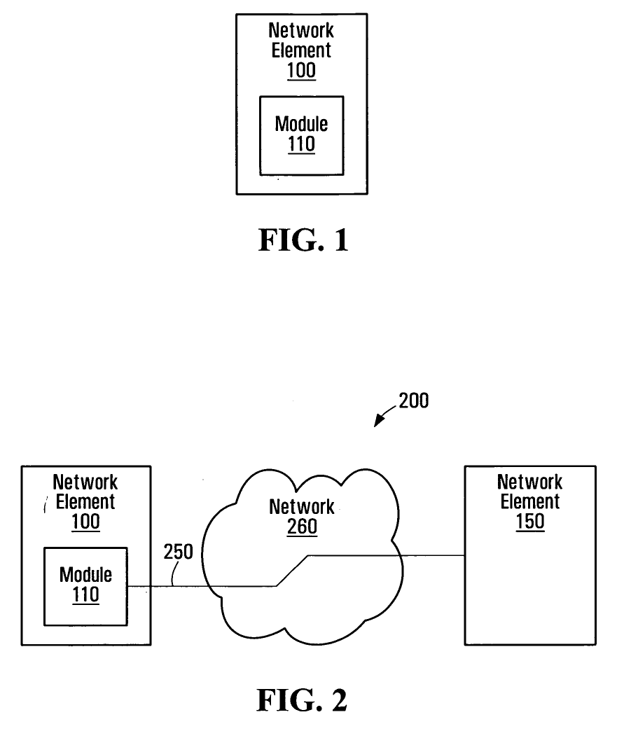

Referring to FIG. 1, a network element 100 comprises a multicast protocol module 110. The multicast protocol module 110 is configured to connect to a layer 2 switched connection control channel in order to communicate, through a switched network, control signals for controlling the communication of multicast data between the network element 110 and another network element. The multicast protocol module 110 is for implementing the multicast protocol and comprises software or hardware or combinations thereof. In some embodiments the multicast protocol module 110 is a protocol stack. In some embodiments, the multicast protocol module 110 is an IGMP (Internet Group Protocol) protocol stack and the layer 2 switched connection control channel is an IGMP control channel. The control signals in these embodiments are IGMP commands, such as REPORT, QUERY, and LEAVE commands. In some embodiments, the control channel is an SVC-IGMP control channel.

Non-limiting examples of the network element 100 include a provider edge; a router; a server; a DSLAM (Digital Subscriber Line Access Multiplexer); and a BRAS.

In use, embodiments of the network element 100 are part of a system. Referring to FIG. 2, an exemplary system 200 comprises the network element 100, a switched network 260 and at least one other network element 150 (only one shown). The module 110 in network element 100 is connected to a layer 2 switched control channel 250, which connects to the network element 150 through the switched network 260. In some embodiments, the network element 150 also comprises a multicast protocol module 110, which is connected to the control channel 250. In some embodiments of the invention, a system comprises a plurality of network elements 100 and each network element 100 can be connected to a plurality of other network elements, either through the switched network or directly.

In some embodiments, the switched network 260 supports both P2P (Point-to-Point) and P2MP (Point-to-Multipoint) communications. Non-limiting examples of the network 260 include an ATM (Asynchronous Transfer Mode) network; an Ethernet; a Frame Relay network; and an MPLS (Multiple Protocol Label Switch) network. By using a SVC over an ATM network for the control channel, for example, there is no requirement that every node in the network comprise a table of the multicast channel addresses because the SVC is switched automatically at each node when given the VPI/VCI of the called network element. An IGMP Report containing a source IP address and an IP Group address is passed over the layer 2 control channel to the upstream router, such as the BRAS, where a P2MP SPVC is launched based on the information in the Report. In addition, an inherent feature of SVCs is the ability to switch to a back-up circuit should there be a failure along the SVC. This provides additional stability to the control channel in embodiments of the present invention. In some embodiments of the invention, the SVC is a P2P circuit.

Where the network is an ATM network, some embodiments of the network element 100 are configured to implement ATM NNI (Network-Network Interface) signalling protocols, such as PNNI (Private Network-Network Interface) signalling. In some embodiments, the network element 100 supports ATM AINI (ATM Internet Interface) signalling links.

In some embodiments of the present invention, the multicast data comprises data for an IPTV (Internet Protocol Television) multicast channel.

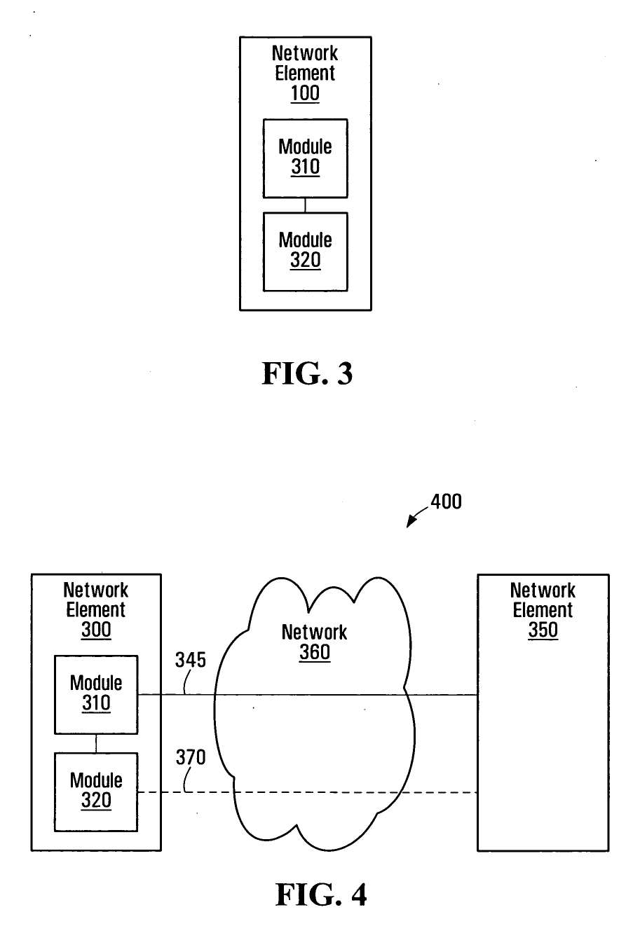

Referring now to FIG. 3, in an embodiment of the present invention, a network element 300 comprises a multicast protocol module 310 and network protocol module 320. The multicast protocol module 310 serves a similar function to the multicast protocol module 110 described with reference to FIG. 1. The network protocol module 320 is for implementing a network protocol and is in communication with the multicast protocol module 310. In addition, the network protocol module 320 is configured to transmit or receive data for a selected multicast channel to/from another network element using a P2MP switched connection, such as but not limited to an SPVC (Soft Permanent Virtual Circuit). If the network element 300 is upstream of the switched network, where upstream means that it is further away from the end user, the network protocol module 320 transmits the multicast data to the other network element, which would be downstream. If the network element 300 is downstream of the switched network, it receives the multicast data from the other network element, which would be upstream.

In some embodiments of the present invention, the network protocol module 320 of the network element 300 is also configured to establish the layer 2 P2MP connection in response to the multicast protocol module 310 receiving a report requesting the selected multicast channel.

As with the network element 100, embodiments of the network element 300 are used in a system. Referring now to FIG. 4, an exemplary system 400 comprises the network element 300, a network 360 and a network element 350. The multicast protocol module 310 of the network element 300 is connected to a layer 2 switched connection control channel 345, which connects to the network element 350 through the network 360. The network protocol module 320 is connected to a P2MP switched connection 370, which is connected to the network element 350 through the network 360. The control channel 345 is for communicating control signals between the two network elements 300 and 350 and the P2MP switched connection 370 is established in response to receiving a request for a multicast channel and is for communicating multicast data for the channel between the two network elements 300 and 350. In some embodiments, the network element 350 also comprises a multicast protocol module and a network protocol module.

In some embodiments, the network element 350 is further connected to a downstream network element, such as a DSLAM, a set-top box, etc and the network element 300 receives multicast data from a source through a multicast enabled network. In some embodiments, the network element 350 receives requests for a particular multicast channel from the downstream network element. If that channel is not being received by the network element 350 already, it passes on the request to the network element 300 over the SVC 345 and the multicast protocol module 310 receives the request. If the channel is already being received at the network element 300, the multicast protocol module 310 instructs the network protocol module to transmit data for the channel to the network element 350. If the channel is not being received at the network element 300, the multicast protocol module 310 will send a request for the channel upstream and instruct the network protocol module 320 to transmit data for the channel to the network element 350. In response to receiving instructions to transmit multicast data to the network element 350, the network protocol module 320 establishes the SPVC 370 and sends the data. When the data is received at the network element 350, it is forwarded to the downstream network element.

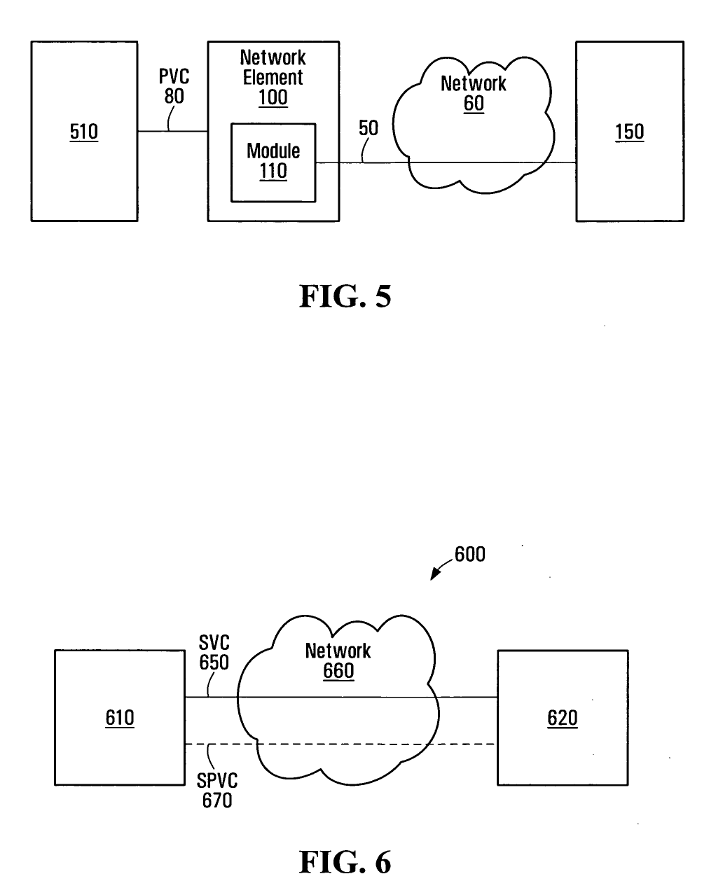

In some embodiments, the network element is also configured to communicate with a further network element over a PVC (Permanent Virtual Circuit) control channel. Referring to FIG. 5, the network element 100 described with reference to FIGS. 1 and 2 communicates with a network element 510 via a PVC control channel 80. As in the system described with reference to FIG. 2, the network element 100 also communicates with the network element 150 via the SVC control channel 50 through the switched network 60. Thus, the network element 100 in some embodiments is between the network 60 and other network elements and may act as an interface with network elements not capable of communicating over the network 60. However, network elements that are capable of communicating over the network 60 can be modified to the configuration of the network element 100.

Now referring to FIG. 6, a system 600 for providing multicast channels, in accordance with an embodiment of the present invention, comprises a first network element 610, and a second network element 620. The second network element 620 is separated from the first network element 610 by a switched network 660. The second network element 620 is in communication with the first network element 610 via an SVC control channel 650 through the switched network 660. The first network element 610 is configured to establish an SPVC 670 between the first network element 610 and the second network element 620 in response to receiving from the first network element a request for a multicast channel over the SVC control channel 650. The SPVC 670 is used for sending data for the multicast channel to the second network element 620. In some embodiments the SPVC 670 is a P2MP circuit.

In some embodiments, the first network element 610 has a table mapping the IP multicast address to a source ATM endpoint that the multicast channel is coming in on. Additionally, the table can map the multicast channel to a VPI/VCI at the second network element 620, i.e. the destination node for the multicast data. The drawback of having the second network element's VPI/VCI on a table at the first network element is that all destination nodes will have to use the same VPI/VCI for the same multicast channels.

To enable destination nodes to use different VPI/VCI for different channels, a table could be in place at the second network element 620, the table specifying which VPI/VCI for each channel. In this case, when the SPVC 670 is launched, the called party number would specify “wildcard” VPI/VCI, triggering the second network element 620 to use its VPI/VCI values from the table.

In some embodiments of the present invention, the network element 610 and/or the network element 620 have a similar configuration to the network element 100 described with reference to FIG. 1. In some embodiments, the network element 610 and/or the network element 620 have a similar configuration to the network element 300 described with reference to FIG. 3.

In some embodiments, the SVC control channel 650 is an IGMP control channel. In some embodiments, the first network element 610 and the second network element 620 each comprise an IGMP protocol module to which the SVC IGMP control channel is connected. In some embodiments, the first network element and the second network element each comprise a network protocol module in communication with the IGMP protocol module. In some embodiments, the network protocol module of the first network element 610 establishes the SPVC 670.

In some embodiments, the first network element 610 receives the multicast data from a multicast source through an IP (Internet Protocol) network.

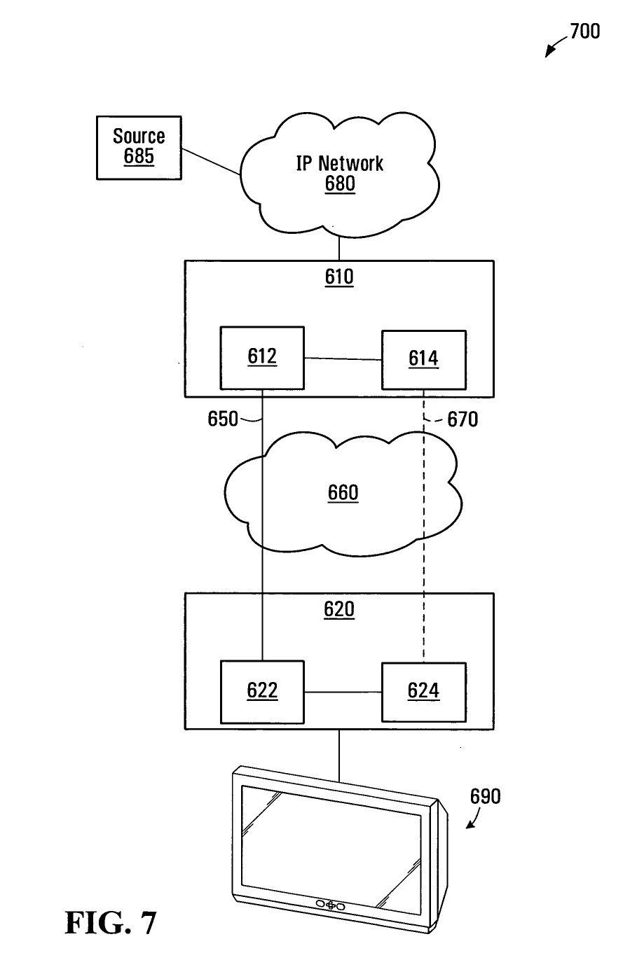

An exemplary system will now be described with reference to FIG. 7. A system 700 comprises the first network element 610, the second network element 620 and the switched network 660 described with reference to FIG. 6. The network elements 610 and 620 each comprise a multicast protocol module 612 and 622, respectively, and a network protocol module 614 and 624, respectively. The system 700 also comprises a user device 690 connected either directly or indirectly to the second network element 620 and at least one multicast source 685 in communication with the first network element 610 through an IP network 680. Non-limiting examples of the multicast source 685 include a satellite, a video camera, an audio transmitter, a video transmitter, a computer, and combinations thereof.

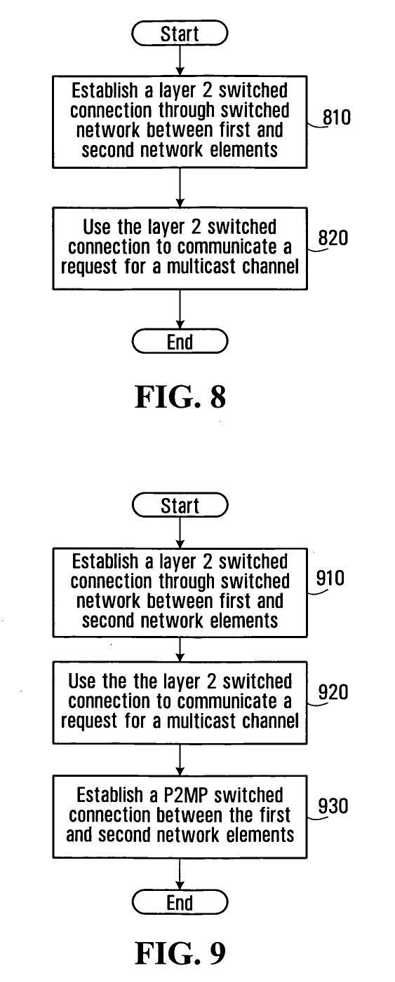

FIG. 8 is a flowchart of a method for providing multicast channels from a first network element to a second network element in accordance with an embodiment of the present invention, where the first network element and the second network element are separated by a switched network. In Step 810 a layer 2 switched connection is established through a switched network between the first network element and the second network element. The layer 2 switched connection is to be used as a control channel. Step 820 comprises using the layer 2 switched connection to communicate a request from the second network element to the first network element, the request being for a user selected multicast channel.

FIG. 9 is a flowchart for a method according to another embodiment of the present invention. Steps 910 and 920 are the same as Steps 810 and 820 from the method described with reference to FIG. 8. Step 930 is establishing a P2MP switched connection from the first network element to the second network element over which to send data for the selected channel, in response to the request. In some embodiments, the P2MP connection is an SPVC over an ATM network.

In some embodiments the method described with reference to FIG. 9 further comprises sending data for the selected channel from the first network element to the second network element over the P2MP switched connection.

In some embodiments, the method described with reference to FIG. 8 further comprises receiving at the second network element the request for the selected multicast channel from a user device.

The methods according to embodiments of the present invention may be implemented using hardware, software or combinations thereof. Accordingly, one embodiment of the present invention comprises a computer readable medium having computer readable instructions stored thereon for implementing any of the methods described herein.

According to one embodiment of the present invention, an upstream router and a downstream router support signalling over a switched network that separates the two routers. In such cases, to implement a method according to one embodiment of the present invention, the following steps are carried out:

Provisioning both the upstream router and the downstream router to become a provider edge to a switched network and use a network protocol to gain access to the switched network that connects the two routers;

Establishing a SVC-IGMP control channel between the downstream router and the upstream router through the switched network. Exemplary ways of establishing the control channel parameters include using an algorithm such as the “higher router IP address” or using explicit provisioning to determine the calling and called party sides. In some embodiments, the SVC-IGMP endpoints are provisioned by an operator at both routers. The determination of called/calling sides may be from upstream router, whereby the control channel is a Router mode IGMP control channel or from the downstream router, whereby the control channel is a. Host mode IGMP control channel.

Transporting IGMP messages between the downstream router and upstream router over the established SVC-IGMP control channel; and

When the downstream router sends a REPORT message to the upstream router, triggering the upstream router to establish a P2MP SPVC with the root originating from the upstream router and the P2MP leaf terminating at the downstream router.

In some embodiments the upstream router and/or the downstream router do not support signalling over the switched network. In these cases an extra network element is introduced between the router(s) and the switched network to establish the SVC control channel and the SPVC across the switched network. In some embodiments, the extra network element is an edge node for the switched network that is adjacent to the router that does not support signalling over the switched network. One manner of implementing these embodiments is as follows:

Establishing a PVC-IGMP control channel between the edge node and the router. In some embodiments, this is done only on the downstream side or the upstream side of the switched network. In other embodiments, a PVC-IGMP control channel is established both on downstream side and one on the upstream side. For purposes of this example only, the remainder of this method assumes that a PVC-IGMP control channel is established on both sides;

Establishing a SVC-IGMP control channel between the downstream edge node and upstream edge node;

When the downstream router sends a REPORT message requesting a multicast channel towards the downstream edge node over the downstream PVC-IGMP control channel, the downstream edge node forwards the message towards the upstream edge node via the SVC-IGMP control channel;

When the upstream edge node receives the REPORT message, it will establish a P2MP SPVC with a root originating from the upstream edge node and a P2MP leaf terminating at downstream edge node;

If IGMP proxy is required, the upstream edge node will also forward the REPORT message toward the upstream router to allow it to make its own crossed-connection in order to feed the multicast stream for the channel toward the upstream edge node.

The methods of embodiments of the present invention may be implemented on any embodiments of the network elements and in any of the systems described herein. Embodiments of the methods described herein are implemented using hardware, software or combinations thereof.

What has been described is merely illustrative of the application of the principles of the invention. Other arrangements and methods can be implemented by those skilled in the art without departing from the spirit and scope of the present invention.

1. A network element comprising:
a multicast protocol module configured to connect to a switched layer 2 control channel, the control channel being for communicating, through a switched network, control signals for controlling the communication of multicast data between the network element and another network element.

2. A network element according to claim 1, further comprising:
a network protocol module for implementing a network protocol, the network protocol module being in communication with the multicast protocol module and being configured to at least one of transmit and receive data for a selected multicast channel to/from the other network element using a P2MP (Point-to-Multipoint) switched connection.

3. The network element of claim 2, wherein the network protocol module is further configured to establish the P2MP switched connection in response to the multicast protocol module receiving a report requesting the selected multicast channel.

4. The network element of claim 1, wherein the switched network supports P2P (Point-to-Point) and P2MP (Point-to-Multipoint) communications.

5. The network element of claim 4, wherein the network is selected from the group consisting of an ATM (Asynchronous Transfer Mode) network; an Ethernet; a Frame Relay network; and an MPLS (Multiple Protocol Label Switch) network.

6. The network element of claim 1, wherein the multicast protocol module is an IGMP (Internet Group Management Protocol) protocol stack and the control channel is a P2P (Point-to-Point) ATM SVC-IGMP control channel.

7. The network element of claim 1, further configured to communicate with a further network element over a PVC (Permanent Virtual Circuit) control channel.

8. The network element of claim 1, wherein the network element is selected from the group consisting of a provider edge; a router; a server; a DSLAM (Digital Subscriber Line Access Multiplexer); and a BRAS.

9. The network element of claim 1, wherein the multicast data comprises data for an IPTV (Internet Protocol Television) multicast channel.

10. A system for providing multicast channels, the system comprising:
a first network element;
a second network element separated from the first network element by a switched network, the second network element being in communication with the first network element via a layer 2 switched control channel through the switched network;
the first network element configured to establish a P2MP (Point-to-Multipoint) switched connection between the first network element and the second network element in response to receiving from the first network element a request for a multicast channel over the control channel, the P2MP switched connection being for sending data for the multicast channel to the second network element.

11. The system of claim 10, wherein the control channel is an IGMP (Internet Group Management Protocol) control channel.

12. The system of claim 11, wherein the first network element and the second network element each comprise an IGMP protocol module to which the IGMP control channel is connected.

13. The system of claim 12, wherein the first network element and the second network element each comprise a network protocol module in communication with the IGMP protocol module.

14. The system of claim 13, wherein the network protocol module of the first network element establishes the SPVC.

15. The system of claim 10, wherein the first network element receives the multicast data from a multicast source through an IP (Internet Protocol) network.

16. A method for providing multicast channels from a first network element to a second network element, the first network element and the second network element being separated by a switched network, the method comprising:
establishing a layer 2 switched connection between the first network element and the second network element to be used as a control channel, the layer 2 switched connection being through the switched network; and
using the layer 2 switched connection to communicate a request from the second network element to the first network element, the request being for a user selected multicast channel.

17. A method according to claim 16, further comprising, in response to the request, creating a P2MP (Point-to-Multipoint) switched connection from the first network element to the second network element over which to send data for the selected channel.

18. A method according to claim 17, further comprising sending data for the selected channel from the first network element to the second network element over the P2MP switched connection.

19. A method according to claim 16, further comprising receiving at the second network element the request for the selected multicast channel from a user device.

20. A computer readable medium having computer readable instructions stored thereon for implementing the method of claim 16.
